(19) United States
(12) Patent Application Publication
(10) Pub. No.: US 2026/0298447 A1
(43) Pub. Date: Oct. 1, 2026

(54) LIGHTING DEVICE

(71) Applicant: STERIS, Merignac (FR)

(72) Inventors: Jean-Marie L'HEGARAT, Saint Aubin De Medoc (FR); Stéphane PENOT, Soussans (FR)

(21) Appl. No.: 19/152,691

(22) PCT Filed: Jan. 22, 2024
(86) PCT No.: PCT/EP2024/051434

§ 371 Date: Jun. 10, 2026

(30) Foreign Application Priority Data
Feb. 2, 2023 (EP) 23154773.8

(51) Int. Cl. F21V 17/06; F21V 3/00

(52) U.S. Cl. CPC F21V 17/06; F21V 3/00

(57) ABSTRACT

A method for producing a lighting device, the device including a body provided with at least one lighting module. The body includes a rim bounding an opening being closed by a cover that is able to allow the light from the lighting module to pass through the cover. The cover is concave in shape and includes a central region that is able to be attached to a central region of the body. The method includes the steps of placing the cover in the form of a flat plate facing the opening in the body so that the periphery of the cover comes into contact, at least partially, with the rim of the body; deforming the flat cover so as to shape it into its concave shape by pressing on the central region of the cover; and attaching the central region of the cover to the central region of the body.

### SCOPE OF DISCLOSURE

The invention relates to a medical lighting device, particularly for an operating room.

### STATE OF THE ART

Such a lighting device typically comprises at least one articulated arm, one end of which is attached and one opposite movable end of which is provided with a lighting module.

The lighting module may be moved by a surgeon so as to direct the light beam towards an area of a patient to be illuminated.

Such a device is known in particular from document EP 3 081 854.

It typically comprises a hollow body containing lighting modules. The body is equipped with a handle and is mounted on an articulated arm. The body also comprises a concave bottom wall and a rim defining an opening closed by a transparent protective cover or screen.

Lighting modules are mounted on the concave wall of the body and are generally intended to illuminate an area at a distance of 1 meter.

The cover may have a concave or convex shape and is typically obtained by injection molding or thermoforming.

Producing such a concave cover before mounting it on the body is relatively complex and costly.

In addition, it appears necessary to improve the seal between the cover and the body in order to prevent liquid from entering the body.

The invention thus aims to propose an alternative method for producing such a lighting device.

### DISCLOSURE OF THE INVENTION

To this end, the present document proposes a method for producing a lighting device, the device comprising a body provided with at least one lighting module, the body comprising a rim defining an opening, said opening being closed by a cover that is able to allow the light from the lighting module to pass through said cover, said cover having a concave shape and comprising a central region suitable for being attached to a central region of the body, the method comprising the steps of:
placing the cover, in the form of a flat plate, facing the opening of the body, so that the periphery of the cover comes into contact, at least partially, with the rim of the body,
deforming the flat cover so as to shape it into its concave shape, by pressing on the central region of the cover,
attaching the central region of the cover to the central region of the body.

In this way, it is possible to first produce the cover in the desired shape, for example, in the form of a cut plate, then to apply the cover to the body before shaping it into its final concave shape by applying a force to the central region of the cover and attaching this region to the body.

Obviously, the deformation remains limited to the deformation capacities of said cover.

Such a production method is less complex and less costly than three-dimensional molding methods, such as those used in the prior art.

Using a flat cover may, in particular, facilitate screen printing on the cover and/or cutting said cover.

The cover may be transparent, at least partially.

The concave shape may be a parabola or a portion of a sphere, for example.

An annular ring may be mounted on the central region of the cover, with a force being applied to said ring so as to deform the cover, and said ring then being secured to the central region of the cover.

The use of such a ring allows the mechanical stresses applied to the cover to be evenly distributed. Such a ring may also provide a seal in this region.

The ring may be secured to the central region of the cover using screws. The screws may be evenly distributed around the periphery of the ring.

The screws may pass through holes in the cover and the ring.

Said ring may be annular.

Said ring may also prevent the cover from warping between the attaching screws.

A seal may be mounted between the rim of the body and the periphery of the cover.

The purpose of this seal is to ensure a sealed interface between the body and the cover, in particular to prevent liquid from entering the internal volume of the body, for example, during cleaning of the device.

The seal may be maintained by the force exerted by the cover under stress.

It should be noted that the seal mounting region may be screw-free, so as to avoid stress and local deformation of the cover.

The seal may be made of an elastomer, for example EPDM rubber or silicone.

The seal may comprise a first groove and a second groove, the rim of the body being engaged in the first groove, the periphery of the cover being engaged in the second groove.

The seal may be held in position on the body by at least one flange comprising a first portion attached to the body and a second portion mounted, at least partially, within the seal.

Such a flange prevents the seal from separating from the body and, thus, the cover from separating from the body.

The seal may be glued to the rim of the body.

The second portion of the flange may be mounted in a groove in the seal.

The second portion of the flange may be mounted in the second groove in the seal.

The first portion of the flange may be screwed onto the body.

The second portion of the flange may be connected to the first portion of the flange by a connecting portion. The connecting portion of the flange may extend substantially perpendicular to the first portion of the flange. The connecting portion may form an angle of between 60° and 90° with the second portion of the flange.

The seal may be held in position on the body by a plurality of flanges distributed along the rim of the body.

The body and the cover may each comprise a central portion from which lobes extend, the cover first being cut from a flat plate before being placed on the rim and being deformed to shape it into its concave shape.

The cover may be made of polycarbonate or PMMA. The cover may be coated with a scratch-resistant coating. Such a coating may be applied before the cover is installed and deformed. This is made possible because the cover may be cold-formed. Indeed, hot molding (injection or thermoforming), as in the prior art, would irreparably damage such a scratch-resistant coating.

The invention also relates to a lighting device obtained using the method according to one of the preceding claims.

The body may be equipped with a handle. The handle may include a removable portion.

The removable portion may thus be removed in order to facilitate the replacement and/or sterilization of said handle.

The lighting device may be a medical lighting device. The lighting device may be a surgical light, in particular for an operating room.

The term “operating room” also includes cases where the lighting device is adapted to a dental chair or a similar sector of activity: examination rooms, emergency rooms, plaster rooms, intensive care units, suture rooms, induction rooms, neonatology, pediatrics, maternity, etc.

The device may include a base, for example, a mobile base equipped with wheels, from which a pole extends, an arm being articulated to the pole, for example at the upper end of the pole.

A lighting head or dome comprising the body may be mounted on the free end of the arm. The articulated arm may comprise several elements connected to each other by joints allowing the lighting head to be moved manually to any point in space and to be oriented in all directions.

Alternatively, the articulated arm may be connected to a fixed point on a wall or ceiling, for example, rather than to a pole secured to a base.

Several lighting modules may be mounted inside the body. At least one lighting module may include an optical unit and an electronic circuit board on which light sources, namely light-emitting diodes, are mounted, arranged opposite collimators formed by the optical unit.

The electronic circuit boards of the modules may be used to control the activation of the various light sources.

The device may also include control means suitable, in particular, for controlling the activation of the various modules and may include, for this purpose, an electronic circuit board. Said electronic circuit board may be mounted and attached within the body.

### BRIEF DESCRIPTION OF THE FIGURES

Other features and advantages of the present disclosure will become apparent in the following detailed description, with reference to the accompanying drawings, in which:

FIG. 1 is a perspective view of a lighting device according to one embodiment of the present document,

FIG. 2 is an exploded perspective view of a portion of the device of FIG. 1,

FIG. 3 is an exploded perspective view of a portion of the device of FIG. 1,

FIG. 4 is a detailed sectional view of a portion of the device of FIG. 1.

### DETAILED DESCRIPTION OF THE DISCLOSURE

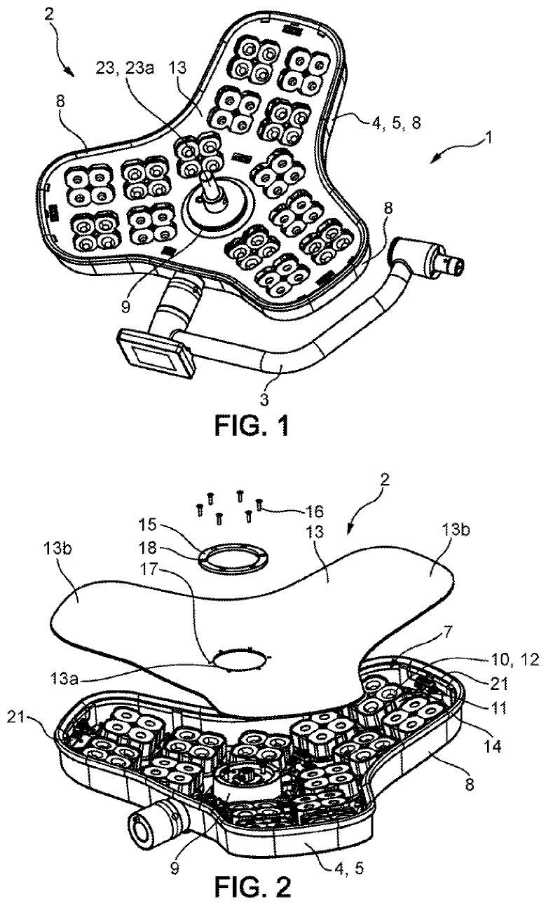

FIGS. 1 to 4 show a lighting device 1 for an operating room, according to one embodiment of the present document.

This lighting device comprises a lighting head or dome 2 which is mounted on the free end of an articulated arm 3.

The lighting head 2 comprises a hollow body 4 comprising a bottom wall and a rim 5. The rim 5 comprises a shoulder 6 and defines an opening 7.

The body 4 comprises a central portion from which three lobes 8 extend. The central portion comprises a hub 9. In addition, lighting modules 10 are mounted inside the body 4. Each module 10 comprises an optical unit 11 and an electronic circuit board on which are mounted four light sources, namely light-emitting diodes, arranged opposite collimators 12 formed by the optical unit 10.

The device 1 also comprises control means suitable, in particular, for controlling the activation of the different modules 10.

The opening of the body 4 is covered by a cover 13 or transparent protective screen. A seal 14 is mounted between the rim 5 and the periphery of the cover 13. The seal 14 may be glued to the rim 5.

The cover 13 comprises a central portion having an opening 13a, for example circular, and lobes 13b extending from the circular portion. The shapes and dimensions of the lobes of the cover 13 correspond to those of the lobes 8 of the body 4.

The central part of the cover 13 is attached to the hub 9 by means of an annular ring 15 and screws 16. In particular, the ring extends around the opening and bears on a surface of the cover 13 facing away from the body 4. The attaching screws 16 ensure the attaching of the ring 15 on the hub 10 and are regularly distributed around the circumference of the ring 15. Said screws 16 pass through holes 17 made in the cover 13 and holes 18 made in the ring 15.

FIG. 4 shows a section of the seal 14. The latter comprises a first groove 19 and a second groove 20. The rim 5 is engaged in the first groove 19, at the shoulder 6. In addition, the outer periphery of the cover 13 is engaged in the second groove 20.

More particularly, said seal 14 comprises a region 14a located outside the rim 5 and the cover 13, and a region 14b located inside said rim 5 and said cover 13. The terms exterior and interior refer to the volume 7 defined by the body 4 and the cover 13. The seal 14 also comprises a region 14c located between the free end of the rim 5 and the cover 13, of lesser thickness e1 than the thickness e2 of the region 14b. The seal 14 may be made of EPDM rubber or silicone.

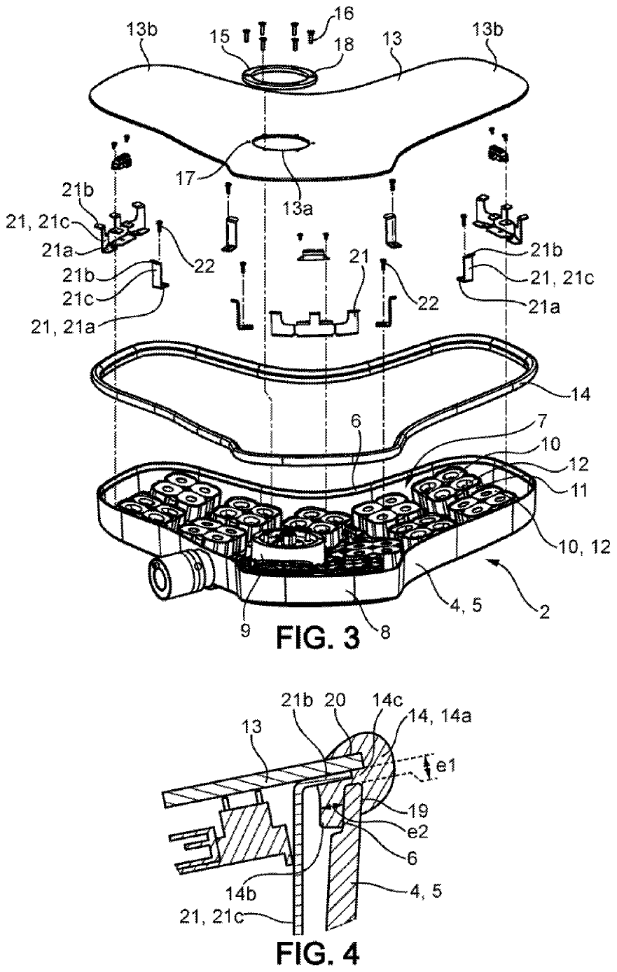

The seal 14 is held by means of flanges 21 (FIG. 3). Each flange 21 comprises at least a first part 21a attached to the body 4, in particular to the bottom surface of the body 4, a second part 21b engaged at least partially in the second groove 20 of the seal 14, and a connecting part 21c. The first part 21a is substantially perpendicular to the connecting part 21c. The second part 21b forms, for example, an angle of between 60 and 90° with the connecting part 21c. The second part 21b bears against or is substantially parallel to the cover 13.

The first part 21a is attached to the body 4 by screws 22.

A handle 23 (FIG. 1) is also mounted on the body 4, in particular on the hub 10, through the opening 13a of the cover 13. Said handle 23 may include a removable part 23a.

Such a device 1 may be produced as follows.

First, the cover 13 is cut from a plate so as to have a central region comprising an opening 13a and lobes 13b extending in the same plane. In addition, the seal 14 may be mounted using the flanges 21 and/or glued to the rim 5. The flat cover 13 is then positioned facing the opening 7 of the body 4, the lobes 13b of the cover 13 being located opposite the lobes 8 of the body 4 and the opening 13a of the plate 13 opposite the hub 9 of the body 4.

The ring 15 may be mounted at the opening 13a and gradually attached using the screws 16. The screwing of the screws 16 causes the deformation of the cover 13 into its concave shape.

1. A method for producing a lighting device (1), the device comprising a body (4) equipped with at least one lighting module (10), the body (4) comprising a rim (5) defining an opening (7), said opening (7) being closed by a cover (13) that is able to allow the light from the lighting module (10) to pass through said cover (13), said cover (13) being concave in shape and comprising a central region suitable for being attached to a central region (10) of the body (4), the method comprising the steps of:
placing the cover (13), in the form of a flat plate, facing the opening in the body (4), so that the periphery of the cover (13) comes into contact, at least partially, with the rim (5) of the body (4),
deforming the flat cover (13) so as to shape it into its concave shape by pressing on the central region of the cover (13),
attaching the central region of the cover (13) to the central region (10) of the body (4).

2. The method according to the preceding claim, wherein an annular ring (15) is mounted on the central region of the cover (13), a force being applied to said ring (15) so as to deform the cover (13), said ring (15) then being attached to the central region of the cover (13).

3. The method according to one of the preceding claims, wherein a seal (14) is mounted between the rim (5) of the body (4) and the periphery of the cover (13).

4. The method according to the preceding claim, wherein the seal (14) comprises a first groove (19) and a second groove (19), the rim (5) of the body (4) being engaged in the first groove (19), the periphery of the cover (13) being engaged in the second groove (19).

5. The method according to one of claims 3 or 4, wherein the seal (14) is held in position on the body (4) by at least one flange (21) comprising a first portion (21a) attached to the body (4), and a second portion (21b) mounted, at least partially, in the seal (14).

6. The lighting method according to the preceding claim, wherein the seal (14) is held in position on the body (4) by a plurality of flanges (21) distributed along the rim (5) of the body (4).

7. The method according to one of the preceding claims, wherein the body (4) and the cover (13) each comprise a central part from which lobes (8, 13b) extend, the cover (13) being first cut from a flat plate before being placed on the rim (5) and being deformed so as to being shaped into its concave shape.

8. The lighting device (1) obtained by the method according to one of the preceding claims.
